(19) United States
(12) Patent Application Publication
(10) Pub. No.: US 2004/0003490 A1
(43) Pub. Date: Jan. 8, 2004

(54) Positioning and spinning device

(76) Inventors: David Shahin, Houston, TX (US); Jeff Habetz, Houston, TX (US)

Correspondence Address: WILLIAM B. PATTERSON, MOSER, PATTERSON & SHERIDAN, L.L.P., Suite 1500, 3040 Post Oak Blvd., Houston, TX, 77056, US

(21) Appl. No.: 10/382,353

(22) Filed: Mar. 5, 2003

Related U.S. Application Data
(63) Continuation-in-part of application No. 09/486,901, filed on May 19, 2000, now Pat. No. 6,591,471.
Application No. 09/486,901 is a 371 of international application No. PCT/GB98/02582, filed on Sep. 2, 1998.

(30) Foreign Application Priority Data
Sep. 2, 1997 (GB) 9718543.3

(51) Int. Cl. B23Q 3/00

(52) U.S. Cl. 29/464

(57) ABSTRACT

The present invention generally relates to a method and apparatus for connecting a first tubular with a second tubular. The apparatus includes a gripping member for engaging the first tubular and a conveying member for positioning the gripping member. The apparatus also includes a spinner for rotating the first tubular. In one embodiment, the spinner includes a motor and one or more rotational members for engaging the first tubular. In another embodiment, the apparatus includes a rotation counting member biased against the first tubular. In another aspect, the present invention provides a method of connecting a first tubular to second tubular. The method includes engaging the first tubular using a gripping member connected to a conveying member and positioning the gripping member to align the first tubular with the second tubular. Thereafter, the first tubular is engaged with the second tubular, and the first tubular is rotated relative to the second tubular using the gripping member.

### CROSS-REFERENCE TO RELATED APPLICATIONS

This application is a continuation-in-part of co-pending U.S. patent application Ser. No. 09/486,901, filed on May 19, 2000, which is the National Stage of International Application No. PCT/GB98/02582, filed on Sep. 2, 1998, and published under PCT article 21(2) in English, which claims priority of United Kingdom Application No. 9718543.3, filed on Sep. 2, 1997. Each of the aforementioned related patent applications is herein incorporated by reference in its entirety.

### BACKGROUND OF THE INVENTION

1. Field of the Invention

The present invention relates to methods and apparatus for connecting tubulars. Particularly, the invention relates an apparatus for aligning and rotating tubulars for connection therewith.

2. Description of the Related Art

In well completion operations, a wellbore is formed to access hydrocarbon-bearing formations by the use of drilling. Drilling is accomplished by utilizing a drill bit that is mounted on the end of a drill support member, commonly known as a drill string. To drill within the wellbore to a predetermined depth, the drill string is often rotated by a top drive or rotary table on a surface platform or rig, or by a downhole motor mounted towards the lower end of the drill string. After drilling to a predetermined depth, the drill string and drill bit are removed and a section of casing is lowered into the wellbore. An annular area is thus formed between the string of casing and the formation. The casing string is temporarily hung from the surface of the well. A cementing operation is then conducted in order to fill the annular area with cement. Using apparatus known in the art, the casing string is cemented into the wellbore by circulating cement into the annular area defined between the outer wall of the casing and the borehole. The combination of cement and casing strengthens the wellbore and facilitates the isolation of certain areas of the formation behind the casing for the production of hydrocarbons.

It is common to employ more than one string of casing in a wellbore. In this respect, one conventional method to complete a well includes drilling to a first designated depth with a drill bit on a drill string. Then, the drill string is removed and a first string of casing is run into the wellbore and set in the drilled out portion of the wellbore. Cement is circulated into the annulus behind the casing string and allowed to cure. Next, the well is drilled to a second designated depth, and a second string of casing, or liner, is run into the drilled out portion of the wellbore. The second string is set at a depth such that the upper portion of the second string of casing overlaps the lower portion of the first string of casing. The second string is then fixed, or “hung” off of the existing casing by the use of slips, which utilize slip members and cones to wedgingly fix the second string of casing in the wellbore. The second casing string is then cemented. This process is typically repeated with additional casing strings until the well has been drilled to a desired depth. Therefore, two run-ins into the wellbore are required per casing string to set the casing into the wellbore. In this manner, wells are typically formed with two or more strings of casing of an ever-decreasing diameter.

As more casing strings are set in the wellbore, the casing strings become progressively smaller in diameter in order to fit within the previous casing string. In a drilling operation, the drill bit for drilling to the next predetermined depth must thus become progressively smaller as the diameter of each casing string decreases in order to fit within the previous casing string. Therefore, multiple drill bits of different sizes are ordinarily necessary for drilling in well completion operations.

Another method of performing well completion operations involves drilling with casing, as opposed to the first method of drilling and then setting the casing. In this method, the casing string is run into the wellbore along with a drill bit for drilling the subsequent, smaller diameter hole located in the interior of the existing casing string. The drill bit is operated by rotation of the drill string from the surface of the wellbore. Once the borehole is formed, the attached casing string may be cemented in the borehole. The drill bit is either removed or destroyed by the drilling of a subsequent borehole. The subsequent borehole may be drilled by a second working string comprising a second drill bit disposed at the end of a second casing that is of sufficient size to line the wall of the borehole formed. The second drill bit should be smaller than the first drill bit so that it fits within the existing casing string. In this respect, this method requires at least one run-in into the wellbore per casing string that is set into the wellbore.

It is known in the industry to use top drive systems to rotate a drill string to form a borehole. Top drive systems are equipped with a motor to provide torque for rotating the drilling string. The quill of the top drive is typically threadedly connected to an upper end of the drill pipe in order to transmit torque to the drill pipe. Top drives may also be used in a drilling with casing operation to rotate the casing.

More recently, gripping heads adapted for use with a top drive have been developed to impart torque from the top drive to the casing. Generally, gripping heads are equipped with gripping members to grippingly engage the casing string to transmit torque applied from the top drive to the casing. Gripping heads may include an external gripping device such as a torque head or an internal gripping device such as a spear. An example of a torque head is disclosed in U.S. Pat. No. 6,311,792, issued to Scott et al., which discloses a torque head having slips for engaging an exterior of the casing.

In addition to imparting torque to the casing, the gripping head may also provide a fluid path for fluid circulation during drilling. Generally, gripping heads define a bore therethrough for fluid communication between the top drive and the casing. Additionally, gripping heads may include sealing members to prevent leakage during circulation.

It is typically necessary to raise or lower the top drive during drilling. For example, the top drive is lowered during drilling in order to urge the drill bit into the formation to extend the wellbore. As the wellbore is extended, additional casings must be added to the casing string. The top drive is released from the casing string and raised to a desired height, thereby allowing the make up of the additional casing to the casing string.

Generally, top drives are disposed on rails so that it is movable axially relative to the well center. While the gripping head may rotate relative to the top drive, it is axially fixed relative to the top drive and thus must remain within the same plane as the top drive and well center. Because movement of the torque head and top drive are restricted, a single joint elevator attached to cable bails is typically used to move additional casings from the rack to well center.

Generally, when the casing is transported from the rack to well center, a rig hand is employed to manipulate the cable bails and angle the elevator from its resting position below the gripping head to the rack. The elevator is closed around one end of the casing to retain control of the casing. The top drive is then raised to pull the elevator and the attached casing to well center.

Once the elevator lifts the casing from the rack, the casing is placed in alignment with the casing string held in the wellbore. Typically, this task is also performed by a rig hand. Because the free end of the casing is unsupported, this task generally presents a hazard to the personnel on the rig floor as they try to maneuver the casing above the wellbore.

A pipe handling arm has recently been developed to manipulate a first tubular into alignment with a second tubular, thereby eliminating the need of a rig hand to align the tubulars. The pipe handling arm is disclosed in International Application Number PCT/GB98/02582, entitled “Method and Apparatus for Aligning Tubulars” and published on Mar. 11, 1999, which application is herein incorporated by reference in its entirety. The pipe handling arm includes a positioning head mounted on a telescopic arm which can hydraulically extend, retract, and pivot to position the first tubular into alignment with the second tubular.

Once the casings are in position, the connection is usually made up by utilizing a spinner and a power tong. Generally, spinners are designed to provide low torque while rotating the casing at a high rate. On the other hand, power tongs are designed to provide high torque with a low turn rate, such as a half turn only. While the spinner provides a faster make up rate, it fails to provide enough torque to form a fluid tight connection. Whereas the power tong may provide enough torque, it fails to make up the connection in an efficient manner because the power tong must grip the casing several times to tighten the connection. Furthermore, the action of gripping and releasing the casing repeatedly may damage the casing surface. Therefore, the spinner and the power tong are typically used in combination to make up a connection.

To make up the connection, the spinner and the power tong are moved from a location on the rig floor to a position near the well center to rotate the casing into engagement with the casing string. Thereafter, the spinner is actuated to perform the initial make up of the connection. Then, the power tong is actuated to finalize the connection. Because operating time for a rig is very expensive, some as much as $500,000 per day, there is enormous pressure to reduce the time they are used in the formation of the wellbore.

There is a need, therefore, for methods and apparatus to reduce the time it takes to make up a tubular connection. There is also a need for an apparatus for aligning tubulars for connection therewith and partly make up the connection while the power tong is moved into position.

### SUMMARY OF THE INVENTION

The present invention generally relates to a method and apparatus for connecting a first tubular with a second tubular. The apparatus includes a gripping member for engaging the first tubular and a conveying member for positioning the gripping member. The apparatus also includes a spinner for rotating the first tubular. In one embodiment, the spinner includes a motor and one or more rotational members for engaging the first tubular. In another embodiment, the apparatus includes a rotation counting member biased against the first tubular.

In another aspect, the present invention provides a method of connecting a first tubular to second tubular. The method includes engaging the first tubular using a gripping member connected to a conveying member and positioning the gripping member to align the first tubular with the second tubular. Thereafter, the first tubular is engaged with the second tubular, and the first tubular is rotated relative to the second tubular using the gripping member.

In another embodiment, the method further comprises determining a position of the gripping member, wherein the position of the gripping member aligns the first tubular with the second tubular, and memorizing the position of the gripping member. Additional tubulars may be connected by recalling the memorized position.

In yet another aspect, the present invention provides a top drive system for forming a wellbore with a tubular. The system includes a top drive, a gripping head operatively connected to the top drive, and a pipe handling arm. The arm may include a gripping member for engaging the tubular and a conveying member for positioning the gripping member. The pipe handling arm also includes a spinner for connecting the first tubular to the second tubular. In another embodiment, the system may also include an elevator and one or more bails operatively connecting the elevator to the top drive.

In another aspect still, the present invention provides a method of forming a wellbore with a tubular string having a first tubular and a second tubular. The method includes providing a top drive operatively connected to a gripping head; engaging the first tubular with a pipe handling arm; and engaging the first tubular with the second tubular. Then, the pipe handling arm rotates the first tubular with respect to the second tubular. Thereafter, the gripping head engages the first tubular and the top drive is actuated to rotate tubular string, thereby forming the wellbore.

### BRIEF DESCRIPTION OF THE DRAWINGS

So that the manner in which the above recited features of the present invention, and other features contemplated and claimed herein, are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a partial view of a rig having a top drive system and a pipe handling arm according to aspects of the present invention.

FIG. 2 is a top view of the pipe handling arm shown in FIG. 1.

FIG. 3 is a cross-section view of the pipe handling arm along line A-A of FIG. 2.

FIG. 4 is a partial view of another embodiment of a pipe handling arm disposed on a rig according to aspects of the present invention.

FIG. 5 is a partial view of the pipe handling arm of FIG. 4 after the casing has been stabbed into the casing string.

FIG. 6 is a partial view of the pipe handling arm of FIG. 4 after the torque head has engaged the casing.

### DETAILED DESCRIPTION OF THE PREFERRED EMBODIMENT

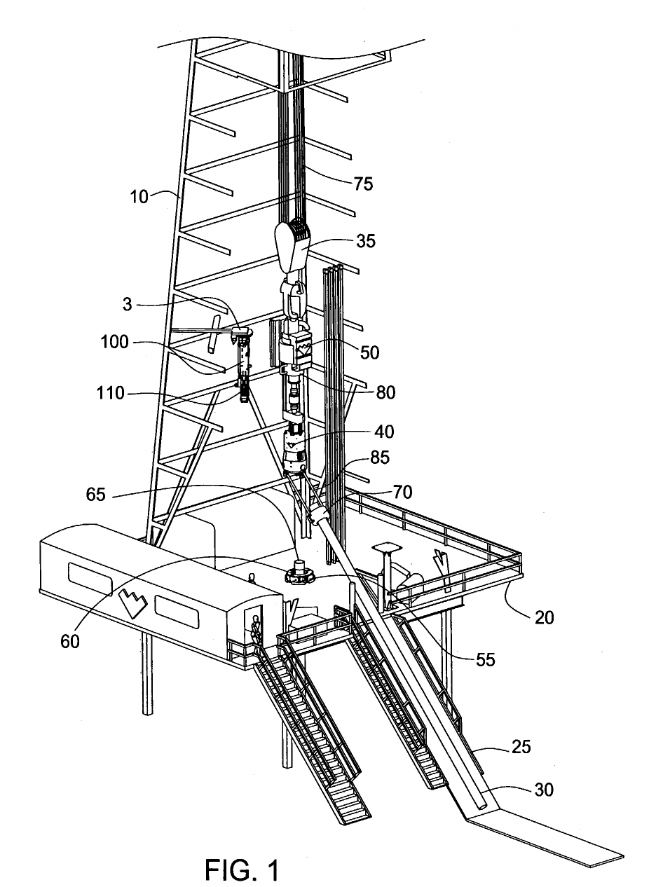

FIG. 1 shows a drilling rig 10 applicable to drilling with casing operations or a wellbore operation that involves picking up/laying down tubulars. The drilling rig 10 is located above a formation at a surface of a well. The drilling rig 10 includes a rig floor 20 and a v-door (not shown). The rig floor 20 has a hole 55 therethrough, the center of which is termed the well center. A spider 60 is disposed around or within the hole 55 to grippingly engage the casings 30, 65 at various stages of the drilling operation. As used herein, each casing 30, 65 may include a single casing or a casing string having more than one casing, and may include a liner, drill pipe, or other types of wellbore tubulars. Therefore, aspects of the present invention are equally applicable to other types of wellbore tubulars, such as drill pipe and liners.

The drilling rig 10 includes a traveling block 35 suspended by cables 75 above the rig floor 20. The traveling block 35 holds the top drive 50 above the rig floor 20 and may be caused to move the top drive 50 axially. The top drive 50 includes a motor 80 which is used to rotate the casing 30, 65 at various stages of the operation, such as during drilling with casing or while making up or breaking out a connection between the casings 30, 65. A railing system (not shown) is coupled to the top drive 50 to guide the axial movement of the top drive 50 and to prevent the top drive 50 from rotational movement during rotation of the casings 30, 65.

Disposed below the top drive 50 is a gripping head 40. The gripping head 40 is utilized to grip an upper portion of the casing 30. The gripping head 40 may include any suitable gripping head known to a person of ordinary skill in the art. Examples of gripping heads 40 include a torque head and a spear. Generally, a torque head employs gripping members such as slips (not shown) to engage the outer surface of the casing 30. An exemplary torque head which may be used with the present invention is disclosed in U.S. Pat. No. 6,311,792 B1, issued on Nov. 6, 2001 to Scott et al., which is herein incorporated by reference. A spear typically includes a gripping mechanism which has gripping members disposed on its outer perimeter for engaging the inner surface of the casing 30.

An elevator 70 operatively connected to the gripping head 40 may be used to transport the casing 30 from a rack 25 or a pickup/lay down machine to the well center. The elevator 70 may include any suitable elevator known to a person of ordinary skill in the art. The elevator defines a central opening to accommodate the casing 30. In one embodiment, bails 85 are used to interconnect the elevator 70 to the gripping head 40. Preferably, the bails 85 are pivotable relative to the gripping head 40. As shown in FIG. 1, the top drive 50 has been lowered to a position proximate the rig floor 20, and the elevator 70 has been closed around the casing 30 resting on the rack 25. In this position, the casing 30 is ready to be hoisted by the top drive 50.

In one aspect, a tubular positioning device 100 is disposed on a platform 3 of the drilling rig 10. The tubular positioning device 100 may be used to guide and align the casing 30 with the casing string 65 for connection therewith. A suitable tubular positioning device 100 includes the pipe handling arm 100 shown in FIG. 1. The pipe handling arm 100 includes a gripping member 150 for engaging the casing 30 during operation. The pipe handling arm 100 is adapted and designed to move in a plane substantially parallel to the rig floor 20 to guide the casing 30 into alignment with the casing 65 in the spider 60.

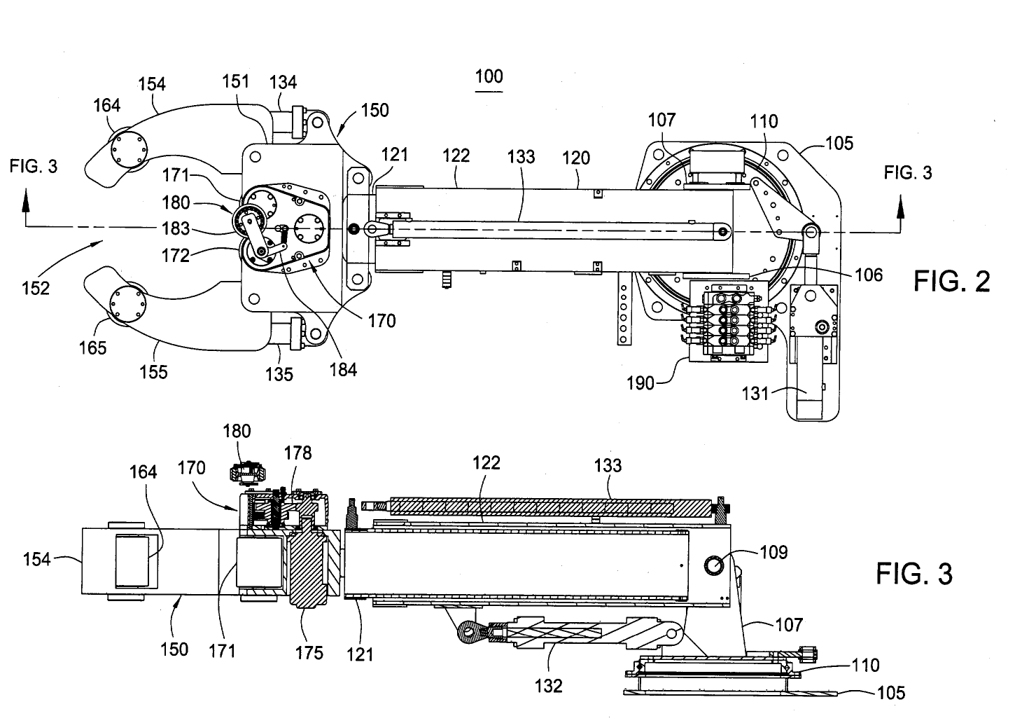

FIGS. 2-3 depict a pipe handling arm 100 according to aspects of the present invention. FIG. 2 presents a top view of the pipe handling arm 100, while FIG. 3 presents a cross-sectional view of the pipe handling arm 100 along line A-A. The pipe handling arm 100 includes a base 105 at one end for attachment to the platform 3. The gripping member 150 is disposed at another end, or distal end, of the pipe handling arm 100. A rotor 110 is rotatably mounted on the base 105 and may be pivoted with respect to the base 105 by a piston and cylinder assembly 131. One end of the piston and cylinder assembly 131 is connected to the base 105, while the other end is attached to the rotor 110. In this manner, the rotor 110 may be pivoted relative to the base 105 on a plane substantially parallel to the rig floor 20 upon actuation of the piston and cylinder assembly 131.

A conveying member 120 interconnects the gripping member 150 to the rotor 110. In one embodiment, two support members 106, 107 extend upwardly from the rotor 110 and movably support the conveying member 120 on the base 105. Preferably, the conveying member 120 is coupled to the support members 106, 107 through a pivot pin 109 that allows the conveying member 120 to pivot from a position substantially perpendicular to the rig floor 20 to a position substantially parallel to the rig floor 20. Referring to FIG. 3, the conveying member 120 is shown as a telescopic arm. A second piston and cylinder assembly 132 is employed to pivot the telescopic arm 120 between the two positions. The second piston and cylinder assembly 132 movably couples the telescopic arm 120 to the rotor 110 such that actuation of the piston and cylinder assembly 132 raises or lowers the telescopic arm 120 relative to the rotor 110. In the substantially perpendicular position, the pipe handling arm 100 is in an unactuated position, while a substantially parallel position places the pipe handling arm 100 in the actuated position.

The telescopic arm 120 includes a first portion 121 slidably disposed in a second portion 122. A third piston and cylinder assembly 133 is operatively coupled to the first and second portions 121, 122 to extend or retract the first portion 121 relative to the second portion 122. In this respect, the telescopic arm 120 and the rotor 110 allow the pipe handling arm 100 to guide the casing 30 into alignment with the casing 65 in the spider 60 for connection therewith. Although a telescopic arm 120 is described herein, any suitable conveying member known to a person of ordinary skill in the art are equally applicable so long as it is capable of positioning the gripping member 150 at a desired position.

The gripping member 150, also known as the “head,” is operatively connected to the distal end of the telescopic arm 120. The gripping member 150 defines a housing 151 movably coupled to two jaws 154, 155. Referring to FIG. 2, a jaw 154, 155 is disposed on each side of the housing 151 in a manner defining an opening 152 for retaining a casing 30. Piston and cylinder assemblies 134, 135 may be employed to actuate the jaws 154, 155. One or more centering members 164, 165 may be disposed on each jaw 154, 155 to facilitate centering of the casing 30 and rotation thereof. An exemplary centering member 164, 165 may include a roller. The rollers 164, 165 may include passive rollers or active rollers having a driving mechanism.

It is understood that the piston and cylinder assemblies 131, 132, 133, 134, and 135 may include any suitable fluid operated piston and cylinder assembly known to a person of ordinary skill in the art. Exemplary piston and cylinder assemblies include a hydraulically operated piston and cylinder assembly and a pneumatically operated piston and cylinder assembly.

In another aspect, the gripping member 150 may be equipped with a spinner 170 to rotate the casing 30 retained by the gripping member 150. As shown in FIG. 3, the spinner 170 is at least partially disposed housing 151. The spinner 170 includes one or more rotational members 171, 172 actuated by a motor 175. The torque generated by the motor 175 is transmitted to a gear assembly 178 to rotate the rotational members 171, 172. Because the rotational members 171, 172 are in frictional contact with the casing 30, the torque is transmitted to the casing 30, thereby causing rotation thereof. In one embodiment, two rotational members 171, 172 are employed and equidistantly positioned relative to a central axis of the gripping member 150. An exemplary rotational member 171 includes a roller. Rotation of the casing 30 will cause the partial make up of the connection between the casings 30, 65. It is understood that the operation may be reversed to break out a tubular connection.

In one aspect, the spinner 170 may be used to perform the initial make up of the threaded connection. The spinner 170 may include any suitable spinner known to a person of ordinary skill in the art. In one embodiment, the spinner 170 may be used to initially make up about 80% or less of a casing connection; preferably, about 70% or less; and most preferably, about 60% or less. In another embodiment, the spinner 170 may be used to initially make up about 95% or less of a drill pipe connection; preferably, about 80% or less; and most preferably, about 70% or less. One advantage of the spinner 170 is that it may rotate the casing 30 at a high speed or continuously rotate the casing 30 to make up the connection. In one embodiment, the spinner 170 may rotate the casing 30 relatively faster than existing top drives or power tongs. Preferably, the spinner 170 may rotate the casing 30 at a rate higher than about 5 rpm; more preferably, higher than about 10 rpm; and most preferably, higher than about 15 rpm. In another embodiment, the spinner 170 may accelerate faster than the top drive 50 or the power tong to rotate the casing 30.

A rotation counting member 180 may optionally be used to detect roller slip. Roller slip is the condition in which the rollers 171, 172 are rotating, but the casing 30 is not. Roller slip may occur when the torque supplied to the rollers 171, 172 cannot overcome the strain in the threaded connection required to further make up the connection. Roller slip may be an indication that the connection is ready for a power tong to complete the make up, or that the connection is damaged, for example, cross-threading. In one embodiment, the rotation counting member 180 includes a circular member 183 biased against the casing 30 by a biasing member 184. Preferably, the circular member 183 is an elastomeric wheel, and the biasing member 184 is a spring loaded lever.

A valve assembly 190 is mounted on the base 105 to regulate fluid flow to actuate the appropriate piston and cylinder assemblies 131, 132, 133, 134, 135. The valve assembly 190 may be controlled from a remote console (not shown) located on the rig floor 20. The remote console may include a joystick which is spring biased to a central, or neutral, position. Manipulation of the joystick causes the valve assembly 190 to direct the flow of fluid to the appropriate piston and cylinder assemblies. The pipe handling arm 100 may be designed to remain in the last operating position when the joystick is released.

In another aspect, the pipe handling arm 100 may include one or more sensors to detect the position of the gripping member 150. In one embodiment, a linear transducer may be employed to provide a signal indicative of the respective extension of piston and cylinder assemblies 131, 133. The linear transducer may be any suitable liner transducer known to a person of ordinary skill in the art, for example, a linear transducer sold by Rota Engineering Limited of Bury, Manchester, England. The detected positions may be stored and recalled to facilitate the movement of the casing 30. Particularly, after the gripping member 150 has place the casing 30 into alignment, the position of the gripping member 150 may be determined and stored. Thereafter, the stored position may be recalled to facilitate the placement of additional casings into alignment with the casing string 65.

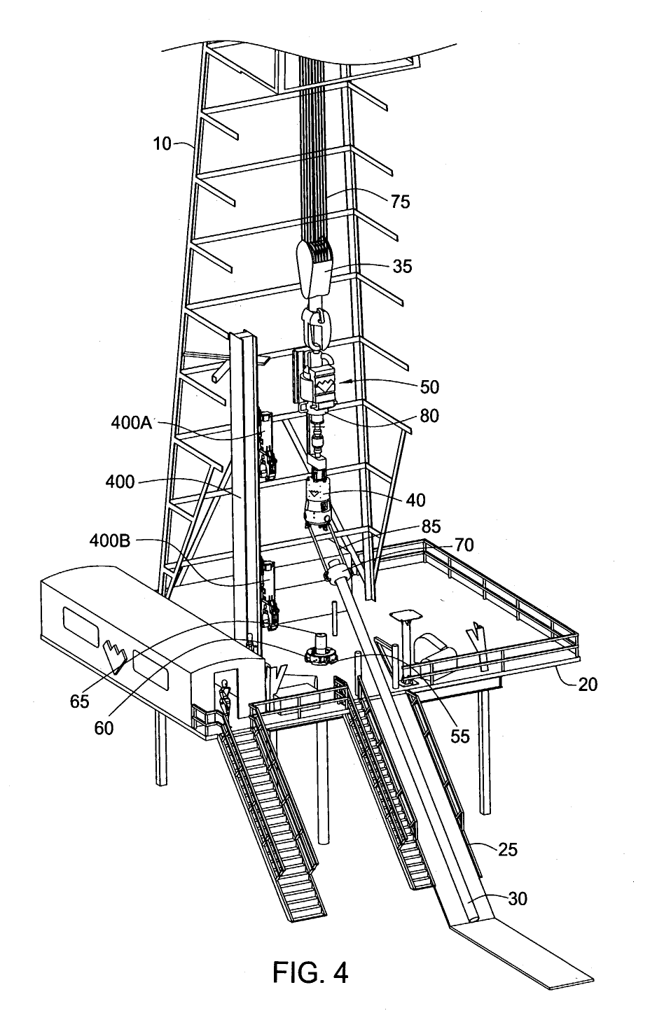

In another embodiment, one or more pipe handling arms 100 may be disposed on a rail 400 as illustrated in FIG. 4. Similar parts shown in FIG. 1 are similarly designated in FIGS. 4-6. As shown in FIG. 4, the rail 400 is disposed on the rig floor 20 with two pipe handling arms 400A, 400B disposed thereon. The rail 400 allows axial movement of the pipe handling arms 400A, 400B, as necessary. The arms 400A, 400B are positioned such that, during operation, one arm 400A grips an upper portion of the casing 30 while the other arm 400B grips a lower portion of the casing 30. In this respect, the arms 400A, 400B may be manipulated to optimally position the casing 30 for connection with the casing string 65.

FIGS. 4-6 show the pipe handling arms 400A, 400B in operation. In FIG. 4, the casing string 65, which was previously drilled into the formation (not shown) to form the wellbore (not shown), is shown disposed within the hole 55 in the rig floor 20. The casing string 65 may include one or more joints or sections of casing threadedly connected to one another. The casing string 65 is shown engaged by the spider 60. The spider 60 supports the casing string 65 in the wellbore and prevents the axial and rotational movement of the casing string 65 relative to the rig floor 20. As shown, a threaded connection of the casing string 65, or the box, is accessible from the rig floor 20.

In FIG. 4, the top drive 50, the torque head 40, and the elevator 70 are shown positioned proximate the rig floor 20. The casing 30 may initially be disposed on the rack 25, which may include a pick up/lay down machine. The elevator 70 is shown engaging an upper portion of the casing 30 and ready to be hoisted by the cables 75 suspending the traveling block 35. The lower portion of the casing 30 includes a threaded connection, or the pin, which may mate with the box of the casing string 65. At this point, the pipe handling arms 400A, 400B are shown in the unactuated position, where the arms 400A, 400B are substantially perpendicular to the rig floor 20.

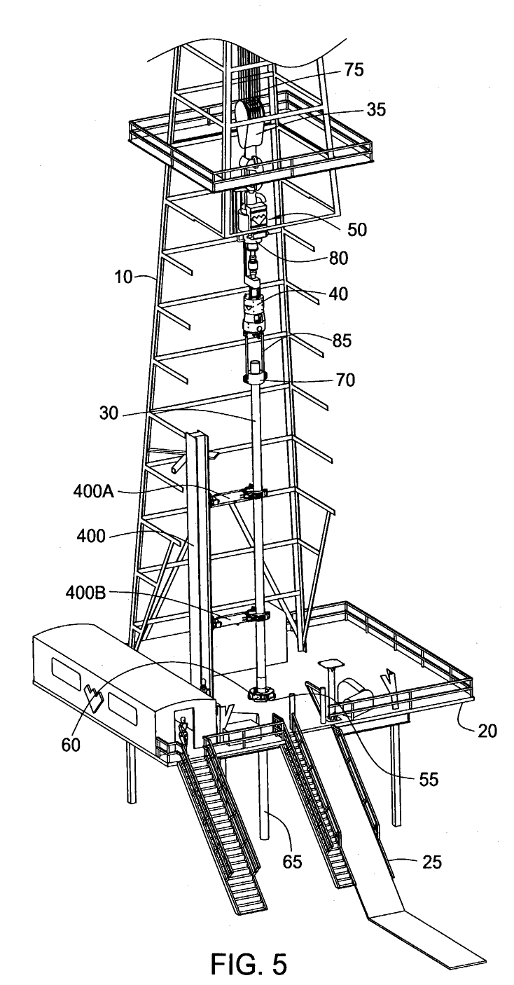

While the casing 30 is being lifted by the traveling block 35, the pipe handling arms 400A, 400B shifts to the actuated position. The second piston and cylinder assembly 132 of each arm 400A, 400B may be actuated to move the respective telescopic arm 120 to a position parallel to the rig floor 20 as illustrated in FIG. 5. After the casing 30 is removed from the rack 25, it is placed into contact with at least one of the pipe handling arms 400A, 400B.

As shown, the casing 30 is positioned proximate the well center and engaged with arms 400A, 400B. The first arm 400A is shown engaged with an upper portion of the casing 30, while the second arm 400B is shown engaged with a lower portion of the casing 30. Particularly, the casing 30 is retained between jaws 154, 155 and in contact with rollers 164, 165, 171, 172. Each arm 400A, 400B may be individually manipulated to align the pin of the casing 30 to the box of the casing string 65. The arms 400A, 400B may be manipulated by actuating the first and third piston and cylinder assemblies 131, 133. Specifically, actuating the first piston and cylinder assembly 131 will move the gripping member 150 to the right or left with respect to the well center. Whereas actuating the third piston and cylinder assembly 133 will extend or retract the gripping member 150 with respect to the well center. In addition, the rotation counting member 180 is biased into contact with the casing 30 by the biasing member 184. After alignment, the pin is stabbed into the box by lowering the pin into contact with the box.

Thereafter, the spinner 170 is actuated to begin make up of the connection. Initially, torque from the motor 175 is transferred through the gear assembly 178 to the rotational members 171, 172. Because the rotational members 171, 172 are in frictional contact with the casing 30, the casing 30 is caused to rotate relative to the casing string 65, thereby initiating the threading of the connection. The rotation of the casing 30 causes the passive rollers 164, 165 to rotate, which facilitates the rotation of the casing 30 in the gripping member 150. At the same time, the rotation counting member 180 is also caused to rotate, thereby indicating that the connection is being made up. It is must noted that the casing 30 may be rotated by either one or both of the pipe handling arms 400A, 400B to make up the connection without deviating from the aspects of the present invention. After the connection is sufficiently made up, the rotational members 171, 172 are deactuated. In this manner, the initial make up of the connection may be performed by the spinner 170 in a shorter time frame than either the top drive or power tong. Additionally, because the pipe handling arm 100 is supporting the casing 30, the load on threaded connection is reduced as it is made up, thereby decreasing the potential for damage to the threads.

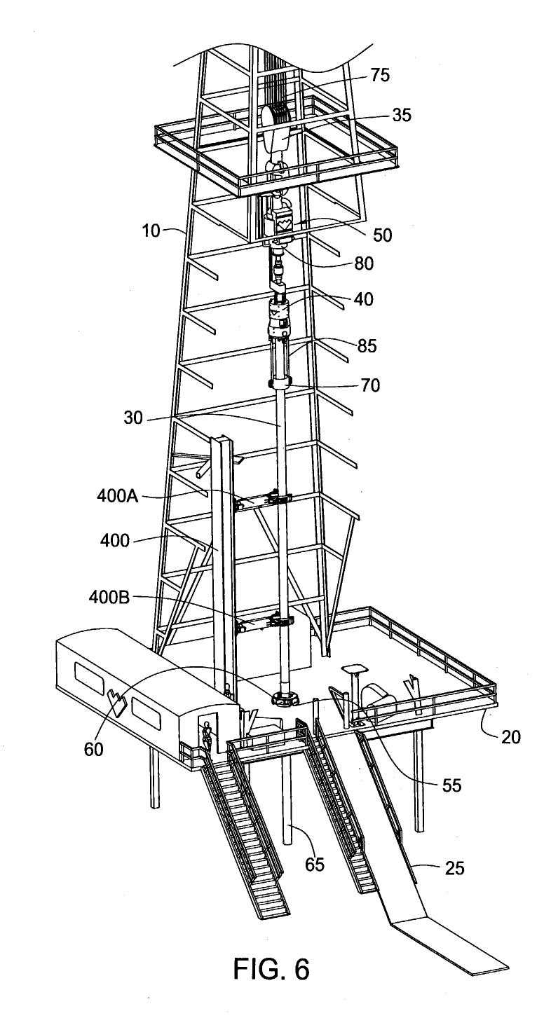

Next, the torque head 40 is lowered relative to the casing 30 and positioned around the upper portion of the casing 30. The slips of the torque head 40 are then actuated to engage the casing 30 as illustrated in FIG. 6. In this respect, the casing 30 is longitudinally and rotationally fixed with respect to the torque head 40. Optionally, a fill-up/circulating tool disposed in the torque head 40 may be inserted into the casing 30 to circulate fluid. After the torque head 40 grippingly engages the casing 30, the jaws 154, 155 of the pipe handling arms 400A, 400B are opened to release the casing 30. Thereafter, the pipe handling arms 400A, 400B are moved away from the well center by shifting back to the unactuated position. In this position, the top drive 50 may now be employed to complete the make up of the threaded connection. To this end, the top drive 50 may apply the necessary torque to rotate the casing 30 to complete the make up process. It is contemplated that a power tong may also be used to complete the make up process.

Although the above operations are described in sequence, it must be noted that at least some of the operations may be performed in parallel without deviating from aspects of the present invention. For example, the torque head 40 may complete the make up process while the pipe handling arms 400A, 400B are shifting to deactuated position. In another example, the torque head 40 may be positioned proximate the upper portion of the casing 30 simultaneously with the rotation of the casing 30 by the spinner 170. As further example, while the spinner 170 is making up the connection, the power tong may be moved into position for connecting the casings 30, 65. By performing some of the operations in parallel, valuable rig time may be conserved.

After the casing 30 and the casing string 65 are connected, the drilling with casing operation may begin. Initially, the spider 60 is released from engagement with the casing string 65, thereby allowing the new casing string 30, 65 to move axially or rotationally in the wellbore. After the release, the casing string 30, 65 is supported by the top drive 50. The drill bit disposed at the lower end of the casing string 30, 65 is urged into the formation and rotated by the top drive 50.

When additional casings are necessary, the top drive 50 is deactuated to temporarily stop drilling. Then, the spider 60 is actuated again to engage and support the casing string 30, 65 in the wellbore. Thereafter, the gripping head 40 releases the casing 30 and is moved upward by the traveling block 35. Additional strings of casing may now be added to the casing string using the same process as described above. In this manner, aspects of the present invention provide methods and apparatus to facilitate the connection of two tubulars.

After a desired length of wellbore has been formed, a cementing operation may be performed to install the casing string 30, 65 in the wellbore. In one embodiment, the drill bit disposed at the lower end of the casing string 30, 65 may be retrieved prior to cementing. In another embodiment, the drill bit may be drilled out along with the excess cement after the cement has cured.

In another aspect, the pipe handling arm 100 may be mounted on a spring loaded base 105. Generally, as the threaded connection is made up, the casing 30 will move axially relative to the casing string 65 to accommodate the mating action of the threads. The spring loaded base 105 allows the pipe handling arm 100 to move axially with the casing 30 to compensate for the mating action. In another embodiment, the pipe handling arm 100 may move axially along the rail 400 to compensate for the mating action.

In another aspect, the pipe handling arms 100 may be used to move a casing 30 standing on a pipe racking board on the rig floor 20 to the well center for connection with the casing string 65. In one embodiment, the arms 400A, 400B on the rail 400 may be manipulated to pick up a casing 30 standing on the rig floor 20 and place it above well center. After aligning the casings 30, 65, the pipe handling arms 400A, 400B may stab the casing 30 into the casing string 65. Then, the spinner 170 may be actuated to perform the initial make up. When the connection is ready for final make up, the torque head 40 is lowered into engagement with the casing 30. Thereafter, the top drive 50 may cause the torque head 40 to rotate the casing 50 to complete the make up process. It is envisioned that the pipe handling arms 400A and 400B may retain the casing 30 while it is being made up by the top drive 50. In this respect, the rollers 164, 165, 171, 172 act as passive rollers, thereby facilitating rotation of the casing 30.

While the foregoing is directed to embodiments of the present invention, other and further embodiments of the invention may be devised without departing from the basic scope thereof, and the scope thereof is determined by the claims that follow.

We claim:

1. An apparatus for connecting a first tubular with a second tubular, comprising:
a gripping member for engaging the first tubular;
a conveying member for positioning the gripping member; and
a spinner for rotating the first tubular.

2. The apparatus of claim 1, wherein the spinner rotates the first tubular relative to the second tubular.

3. The apparatus of claim 1, wherein the spinner continuously rotates the first tubular to the second tubular to make up the connection.

4. The apparatus of claim 1, wherein the spinner performs a portion of the make up process.

5. The apparatus of claim 4, wherein the spinner performs about 80% or less of the make up process.

6. The apparatus of claim 1, wherein the spinner comprises a motor and one or more rotational members for engaging the first tubular.

7. The apparatus of claim 6, wherein the one or more rotational members comprise a roller.

8. The apparatus of claim 1, further comprising a rotation counting member.

9. The apparatus of claim 8, wherein the rotation counting member is biased against the first tubular.

10. The apparatus of claim 1, further comprising:
a sensing device responsive to a position of the gripping member; and
means for memorizing the position of the gripping member, wherein the apparatus is capable of returning the gripping member to the memorized position.

11. The apparatus of claim 1, wherein the gripping member is remotely controllable.

12. The apparatus of claim 1, wherein the conveying member is coupled to an axially movable base.

13. The apparatus of claim 1, wherein the apparatus is mounted on a rail.

14. The apparatus of claim 1, wherein the conveying member comprises a telescopic arm.

15. The apparatus of claim 14, wherein the telescopic arm is mounted on a rotor which is pivotally mounted on a base.

16. A method of connecting a first tubular to second tubular, comprising:
engaging the first tubular using a gripping member connected to a conveying member;
positioning the gripping member to align the first tubular with the second tubular;
engaging the first tubular with the second tubular; and
rotating the first tubular relative to the second tubular using the gripping member.

17. The method of claim 16, further comprising:
determining a position of the gripping member, wherein the position of the gripping member aligns the first tubular with the second tubular; and
memorizing the position of the gripping member.

18. The method of claim 17, further comprising recalling the memorized position to position a third tubular.

19. The method of claim 16, wherein positioning the gripping member comprises actuating the conveying member.

20. The method of claim 16, wherein the first tubular is rotated with a spinner.

21. The method of claim 20, wherein the spinner rotates the first tubular relatively faster than a top drive.

22. The method of claim 16, further comprising making up about 80% or less of a connection between the first tubular and the second tubular.

23. The method of claim 16, further comprising detecting a rotation of the first tubular.

24. The method of claim 23, further comprising providing a rotation counting member to detect the rotation of the first tubular.

25. A top drive system for forming a wellbore with a tubular, comprising:
a top drive;
a gripping head operatively connected to the top drive; and
a pipe handling arm having:
a gripping member for engaging the tubular;
a conveying member for positioning the gripping member; and
a spinner for connecting the first tubular to the second tubular.

26. The top drive system of claim 25, further comprising:
an elevator;
one or more bails operatively connecting the elevator to the top drive.

27. The top drive system of claim 25, wherein the spinner comprises one or more rotational members for engaging the tubular.

28. A method of forming a wellbore with a tubular string having a first tubular and a second tubular, comprising:
providing a top drive operatively connected to a gripping head;
engaging the first tubular with a pipe handling arm;
engaging the first tubular with the second tubular;
rotating the first tubular with respect to the second tubular using the pipe handling arm;
engaging the first tubular with the gripping head; and
rotating the tubular string using the top drive, thereby forming the wellbore.

29. The method of claim 28, further comprising aligning the first tubular with the second tubular.

30. The method of claim 29, further comprising manipulating the pipe handling arm to align the first tubular with the second tubular.

31. The method of claim 28, further comprising performing a portion of the make up process using the pipe handling arm.

32. The method of claim 31, further comprising completing the make up process using the top drive.

33. The method of claim 32, wherein the top drive supplies a greater amount of torque than the pipe handling arm.

34. The method of claim 32, wherein the pipe handling arm rotates the first tubular faster than the top drive.

35. The method of claim 28, further comprising engaging the tubular string with a spider.

36. The method of claim 35, further comprising adding a third tubular to the tubular string.

37. The method of claim 28, further comprising cementing the tubular string.
